(19) United States
(12) Patent Application Publication
(10) Pub. No.: US 2002/0070483 A1
(43) Pub. Date: Jun. 13, 2002

(54) Method of eliminating flaws on smooth plastic surfaces

(76) Inventor: Yang-Shiau Chen, Taipei (TW)

Correspondence Address: BACON & THOMAS, 4th Floor, 625 Slaters Lane, Alexandria, VA, 22314, US

(21) Appl. No.: 09/732,777

(22) Filed: Dec. 11, 2000

(51) Int. Cl. B29C 71/04; B24B 1/00; B29C 45/00; B29C 71/02

(52) U.S. Cl. 264/478; 264/482; 264/162; 264/234

(57) ABSTRACT

A method of eliminating flaws on smooth plastic surfaces, the method aims at removing flaws of knots of material, joint lines, weldlines or scrapes formed at joints by mold releasing or processing on the smooth plastic surfaces of shaped plastic articles; thereby the surfaces of the finished plastic article can be smooth and kept intact, and products with flaws can be eliminated. The present invention is characterized mainly by: when a plastic article is injection molded, the areas with flaws on the external surfaces of the finished article is ground to nearly plain, and the external surfaces are separated for windless heating to a melting point to render the flaw areas on the external surfaces of the finished article to melt integrally with the plain areas, and after cooling of the molten areas on the external surfaces of the finished article, smooth surfaces are formed. And products with flaws can be eliminated.

### BACKGROUND OF THE INVENTION

1. Field of the Invention

The present invention is related to a method of eliminating flaws on smooth plastic surfaces; and is especially related to a method wherein plastic is shaped by injection molding, the external surfaces of a finished plastic article is separated for windless heating to a melting point to render the flaw areas on the external surfaces of the finished plastic article to melt integrally with the plain areas; and after cooling of the molten areas on the external surfaces of the finished plastic article, smooth surfaces are formed.

2. Description of the Prior Art

It is well known that, injection molded plastic articles have quite a wide scope of application, such as being used as lamp guards for headlights of a car, a housing of a computer, stationeries etc. Almost all daily necessities use injection molded plastic; however, during injection molding of plastic, surfaces thereof may have knots of material, joint lines or weldlines, and scrapes may be resulted during mold releasing by negligence of people or bad designing of molds. When such flaws of knots of material, joint lines, weldlines or scrapes are created, except those created by negligence of people, they occur on the similar locations of every injection molded plastic article of a batch of products. This leaves quite a big trouble for the manufacturers.

The aforesaid flaws on injection molded plastic articles generally are removed by grinding and polishing processes; however, grinding and polishing do not suit every kind of injection molded plastic, especially when the plastic articles have smooth or transparent surfaces. Once they are ground, foggy areas are left on the ground surfaces. Even when a secondary polishing process is practiced, some deeper grinding marks still cannot be removed to make intact and smooth surfaces on the shaped plastic articles. In more serious cases, a buyer may return a whole batch of shaped plastic articles and make a loss on finance and reputation of the manufacturer. This is also a problem not able to be solved in the art. Alternatively, some manufacturers cover the flaws with spray paint on the plastic surfaces. However, such measures must have the paint sprayed twice after the plastic surfaces are ground and polished to make them plain and smooth, the flaws can then be completely removed. This not only makes higher cost, but also renders the plastic surfaces to be subjected to damage of scraping during such processing; thus customers may doubt about the quality of the products. Besides, the method of covering the flaws with spray paint on the plastic surfaces does not suit transparent plastic articles; it is adverse to the original intension of design of the injection molded transparent plastic articles.

### SUMMARY OF THE INVENTION

In view that the flaws on the smooth surfaces of the injection molded plastic articles can not be removed, the inventor of the present invention provides “the method of eliminating flaws on a smooth plastic surface” to overcome the problem long existing in the art of plastic shaping based on his professional experience of years in designing and manufacturing same kind of products and after continuous study and improving.

In particular, “the method of eliminating flaws on smooth plastic surfaces” of the present invention aims at removing flaws of knots of material, joint lines, weldlines or scrapes formed at joints by mold releasing or processing on the smooth plastic surfaces of shaped plastic articles; thereby the surfaces of the finished plastic article can be smooth and kept intact, and products with flaws can be eliminated. The present invention is characterized mainly by: when a plastic article is injection molded, the external surfaces of the finished article is separated for windless heating to a melting point to render the flaw areas on the external surfaces of the finished article to melt integrally with the plain areas, and after cooling of the molten areas on the external surfaces of the finished article, smooth surfaces are formed.

Therefore, the primary object of the present invention is to provide “a method of eliminating flaws on smooth plastic surfaces”; by the technical characteristics thereof, the external surfaces of the finished article are separated for windless heating to a melting point to render the flaw areas on the external surfaces of the finished article to melt integrally with the plain areas, and after cooling of the molten areas on the external surfaces of the finished article, smooth surfaces are formed at the flaw areas and the plain areas. Thus not only the flaws on the external surfaces of the finished article can be removed, but also the finished article can be kept intact. And products with flaws can be eliminated.

A secondary object of the present invention is to provide “a method of eliminating flaws on smooth plastic surfaces”; by the present invention, the flaw areas can be melted integrally with the plain areas to form an intact surface on the shaped plastic article, so that a perfect surface of the shaped plastic article can be obtained, and added value of the article can be elevated.

Another object of the present invention is to provide “a method of eliminating flaws on smooth plastic surfaces”; by the present invention, inferior products can be avoided, and cost of production can be reduced.

The present invention will be more apparent after reading the detailed description of the preferred embodiment thereof in reference to the accompanying drawings.

### BRIEF DESCRIPTION OF THE DRAWINGS

FIG. 1 is a schematic perspective view showing a mold for injection molding;

FIG. 2 is a schematic perspective view showing a flaw is eliminated by the present invention.

### DETAILED DESCRIPTION OF THE PREFERRED EMBODIMENT

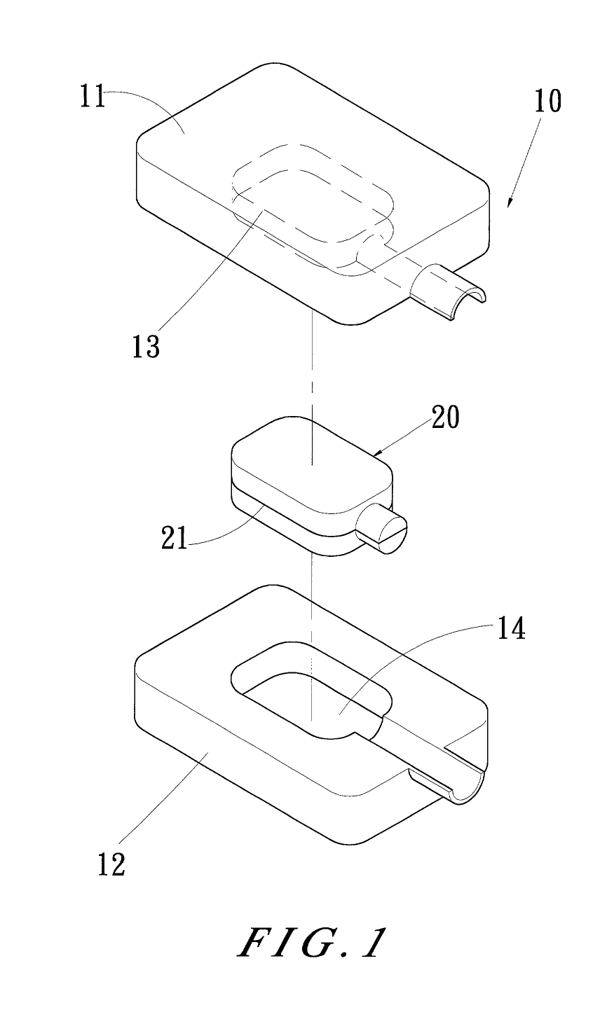

Referring to FIG. 1 in the attached drawings, the technique of plastic injection molding includes heating the plastic material to melt and cast it into a mold 10 which is composed of an upper die 11 and a lower die 12. The upper and lower dies 11, 12 are provided on their mutually confronting surfaces with die cavities 13, 14, respectively. Hot molten plastic is cast into the die cavities 13, 14 of the upper and lower dies 11, 12, after it is cooled, the upper and lower dies 11, 12 can be separated, and the shaped plastic article 20 can be removed from the die cavities 13, 14.

The structure of the upper and lower dies 11, 12 of the mold 10 is just a simplest example; if the shaped plastic article 20 after being injection molded is more complicated in structure, the mold 10 may be designed to include a plurality of die blocks, and possibly some slide blocks and movable lateral plates shall be added. In the mold 10 depicted in the drawing, the upper and lower dies 11, 12 have slits at the joint therebetween; after injection molding, the shaped plastic article 20 has knots of material and joint lines at the joint of the locations corresponding to those of the joint of the upper and lower dies 11, 12, these are the flaws on the external surfaces of the finished plastic article 20.

Conventionally, the flaws of the knots of material and joint lines 21 on the finished plastic article 20 are removed by grinding process. Although the surfaces of the finished plastic article 20 after removing is nearly plain, the surfaces may have thereon foggy grinding marks, thereby, a process of a secondary polishing technique is required to make smooth of the surfaces of the finished plastic article 20.

Although substantially perfect smooth surfaces can be obtained by surface polishing of the injection molded plastic article 20, it can only be effected when the knots of material and joint lines 21 on the finished plastic article 20 are ground to get a completely plain state, otherwise, the knots of material and joint lines 21 still leave raised granules or lines on the finished plastic article 20 although the surfaces are smooth by polishing. No matter which tool is used to polish, there are grinding marks more or less; deep marks will not be removed by polishing.

Therefore, as to removing of the flaws on the surfaces of the smooth plastic article, grinding may be necessary for primary removing of larger flaws, however, for the smaller scrapes or grinding marks, grinding and polishing are absolutely not the ideal methods.

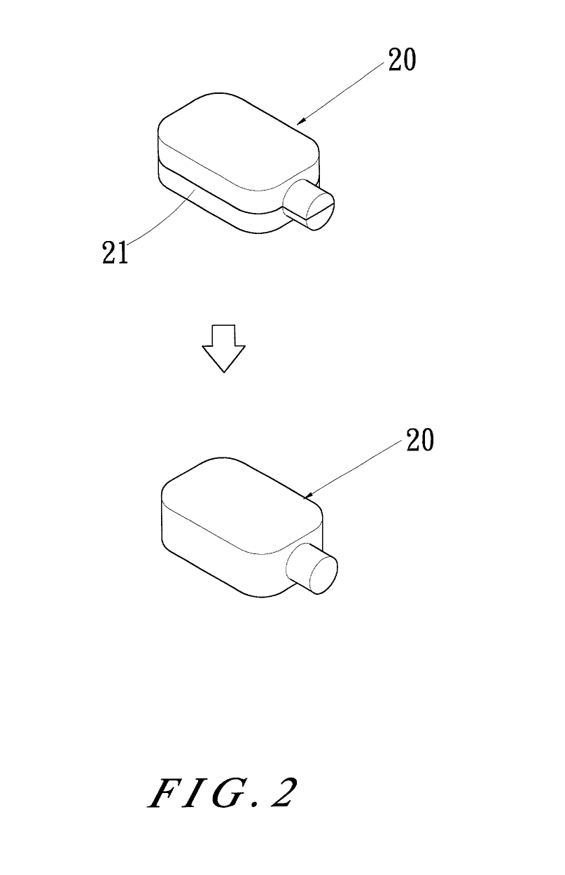

As shown in FIG. 2, in “the method of eliminating flaws on smooth plastic surfaces” of the present invention, after injection molding and shaping of plastic, the exterior surfaces of the shaped plastic articles 20 are separated for windless heating to a melting point, heating shall cover the areas with flaws (the knots of material and joint lines 21) and the plain areas at the rims of the areas with the flaws. The external surfaces with the flaws of the finished article 20 and the plain areas are melted to be integral, and after cooling of the molten areas on the external surfaces of the finished article 20, smooth surfaces are formed. Thus the object of elimination of flaws can be achieved.

In the method of elimination of flaws of the present invention, the object of separation for windless heating of the surfaces of shaped plastic articles 20 mainly is based on the fact that molten plastic is in the form of semi-liquid plaster, at this time, if it is heated with igniting gas such as acetylene or coal gas from a nozzle, the wind pressure of the acetylene or coal gas will make recesses on the molten plastic surfaces, and after cooling, the surfaces will be uneven and form another kind of flaw. Besides, if it is heated by contacting between a tool and the finished article 20, the contact portions are subjected to deformation, thus the external surfaces will be unable to be smooth. Thereby, the external surfaces of the finished article 20 of the present invention had better be separated for windless heating to a melting point. When in practice, heating with illumination of a light source, such as a laser light source, is preferred.

Heating of the external surfaces of the finished article 20 of the present invention covers the areas with flaws and the plain areas at the rims of the areas with the flaws. The external surfaces with the flaws and the plain areas are melted to be integral mainly based on the fact that molten plastic plaster will flow. If a flaw is a scrape, the molten plastic plaster can fill up the recessed scrape; if it is a joint line, redundant plastic plaster may be distributed uniformly to other locations, so that the external surfaces of the finished article can be smooth.

Generally, when a shaped plastic article is used on a commodity with a higher added value, it is required for higher Quality; relatively, a mold for it is also designed in a more delicate way, so that the flaws on the injection molded plastic article can be finer. At this time, the stated present invention can be successfully used to remove the flaws. However, if the shaped plastic article is used on a commodity with a lower added value, it is required for lower quality; relatively, a mold for it is also designed in a coarser way, so that the flaws on the injection molded plastic article can be larger. At this time, the present invention can also be used to remove the flaws by eliminating the foggy areas created by grinding the areas with the flaws to make them nearly plain.

The names of the members composing the above embodiment and shown in the drawings are only for illustrating a preferred embodiment of the present invention, and not for giving any limitation to the scope of the present invention. Accordingly, all such modifications and changes also fall within the scope of the appended claims and are intended to form part of this invention.

1. A method of eliminating flaws on smooth plastic surfaces, said method is characterized by: when a plastic article is injection molded, the external surfaces of the finished plastic article are separated for windless heating to a melting point, heating portions cover the areas with flaws and plain areas at the rims of said areas with the flaws, said external surfaces with said flaws on said finished plastic article and said plain areas are melted to be integral, after cooling of the molten areas on said external surfaces of said finished plastic article, smooth surfaces are formed, thus an object of elimination of flaws is achieved.

2. A method of eliminating flaws on smooth plastic surfaces as stated in claim 1, wherein said heating is done by heating with illumination of a light source.

3. A method of eliminating flaws on smooth plastic surfaces as stated in claim 2, wherein said heating with illumination uses a laser light.

4. A method of eliminating flaws on smooth plastic surfaces as stated in claim 1, wherein said heating is done when said areas with flaws are made nearly plain to remove foggy areas created by grinding.
